(19) United States
(12) Patent Application Publication
(10) Pub. No.: US 2015/0242144 A1
(43) Pub. Date: Aug. 27, 2015

(54) STORAGE DEVICE, CONTROLLER, AND NON-TRANSITORY COMPUTER-READABLE RECORDING MEDIUM HAVING STORED THEREIN CONTROL PROGRAM

(71) Applicant: FUJITSU LIMITED, Kawasaki-shi (JP)

(72) Inventor: Kinya Saito, Kawasaki (JP)

(21) Appl. No.: 14/606,765

(22) Filed: Jan. 27, 2015

(30) Foreign Application Priority Data
Feb. 26, 2014 (JP) 2014-035548

(51) Int. Cl. G06F 3/06

(52) U.S. Cl. CPC G06F 3/0619; G06F 3/065; G06F 3/067

(57) ABSTRACT

A storage device communicably connected to another storage device. The storage device includes a plurality of copy buffers of two or more types that are to store data to be transmitted to the other storage device, a first delay time measure that measures a first delay time occurring on a communication path between the storage device and the other storage device, and a copy buffer selector that selects, on the basis of a result of comparison between the largeness of the first delay time and that of a threshold, one from the plurality of copy buffers as a copy buffer that is to store the data to be transmitted to the other storage device.

### CROSS-REFERENCE TO RELATED APPLICATION

This application is based upon and claims the benefit of priority of the prior Japanese Patent application No. 2014-035548, filed on Feb. 26, 2014, the entire contents of which are incorporated herein by reference

### FIELD

The embodiment discussed herein is a storage device, a controller, and a non-transitory computer-readable recording medium having stored therein a control program.

### BACKGROUND

One of the known storage systems has a structure of a Disaster Recovery (DR) system to enhance the reliability of the entire system. To ensure the redundancy of the data stored in a primary site, a DR system copies data from the primary site to the DR site.

Data copying in a DR system is typically carried out in a synchronous or asynchronous manner.

FIG. 10 is an example of synchronous data copying performed in a traditional storage device.

Hereinafter, like reference numbers designate similar or identical elements and parts throughout the description, so repetitious description will be omitted.

A storage network 2000 illustrated in the accompanying drawing FIG. 10 includes two storage systems 200 to structure a DR system.

Each storage system 200 includes a storage device 4 (storage device #0 or #1) and a server 5 (server #0 or #1). The storage device is communicably connected to the server 5 in each storage system 200.

Hereinafter, when one of the multiple storage devices needs to be specified, the storage device is represented by a “storage device #0” or the “storage device #1”, but an arbitrary storage device is represented by a “storage device 4”. Likewise, when one of the multiple servers needs to be specified, the server is represented by a “server #0” or “server #1”, but an arbitrary server is represented by a “server 5”.

An example of the server 5 is a computer (information processing apparatus) having a server function.

In the example of FIG. 10, the storage device #0 is a primary site and the storage device #1 is a DR site. The storage device #0 is communicably connected to the storage device #1 via, for example, a network.

Each storage device 4 includes a Controller Module (CM) 40 and a Disk Enclosure (DE) 50. The CM 40 is communicably connected to the DE 50 via, for example, a bus.

The CM 40 is a controller responsible for various controls, and functions in response to a storage access command (access control signal: hereinafter called a host I/O) from the server 5. A CM 40 includes a cache memory 420, a primary copy buffer 421, and additional non-illustrated functional configuration such as a Central Processing Unit (CPU).

The cache memory 420 stores therein data received from the server 5 and data read from a storing device 51 that is to be detailed below. Data (write data and write cache data) that is received from the server 5 and is to be written into the storing device 51 is stored in a predetermined region (i.e., user region) of the cache memory 420 and is transferred to the storing device 51 afterwards.

The primary copy buffer 421 is a First-In First-Out (FIFO) memory that stores therein packets to be sent to and received from another storage device 4.

The DE 50 includes the storing device and a secondary copy buffer 52.

The storing device 51 is a traditional device that stores therein data in a writable and readable manner and is exemplified by a Hard Disk Drive (HDD) or a Solid State Drive (SSD). In the example of FIG. 10, the DE 50 includes a single storing device 51 but may alternatively include multiple storing devices 51 being different in type.

The secondary copy buffer 52 is a storing device complementary to the cache region of the above cache memory 420. The cache memory 420 is also used as a shared region for data reading and writing not related to the synchronous data copying, so that the available volume of the cache memory 420 is reduced. As a solution to this, part of the devices that the DE 50 includes is set to be the secondary copy buffer 52 to complement the reduction of the cache volume in the synchronous data copying.

[Patent Literature 1] Japanese Laid-open Patent Publication No. 2007-328468

[Patent Literature 2] Japanese Laid-open Patent Publication No. 2007-115138

Hereinafter, the synchronous data copying in the storage network 2000 of FIG. 10 will now be detailed.

The server #0 sends data to be written into the storing device 51 to the storage device #0, and the CM 40 temporarily stores the received data in the cache memory 420 (see Arrow C1).

The CM 40 stores the data temporarily stored in the cache memory 420 into the storing device 51 (see Arrow C2).

The CM 40 temporarily stores data output from the cache memory 420, as data to be stored into the storage device #1, in the secondary copy buffer 52 (see Arrow C3).

The CM 40 reads the data temporarily stored in the secondary copy buffer 52 and temporarily stores the read data in the primary copy buffer 421 (see Arrow C4).

Then, the CM 40 reads the data temporarily stored in the primary copy buffer 421, and sends the read data to the storage device #1. The CM 40 of the storage device #1 temporarily stores the received data in the cache memory 420 (see Arrow C5).

Upon temporarily storing the received data in the cache memory 420, the CM 40 of the storage device #1 sends response data to the storage device #0. The CM 40 of the storage device #0 temporarily stores the received response data in the primary copy buffer 421 (see Arrow C6).

The CM 40 of the storage device #0 reads the response data temporarily stored in the primary copy buffer 421, and sends the read response data to the server #0 (see Arrow C7). This allows the server #0 to recognize the completion of the synchronous data copying.

In contrast, the CM 40 of the storage device #1 stores the data temporarily stored in the cache memory 420 into the storing device 51 (see Arrow C8).

The time that the processes represented by Arrows C1 and C2 take is called asynchronous copying time while the time that processes represented by Arrows C1, C3, C4, C5, and C6 is called synchronous copying time.

In the traditional storage system 200, the access time (see Arrow C2) to the storing device 51, the access time (see Arrows C3 and C4) to the secondary copy buffer 52, and the line delay time (see Arrows C5 and C6) between the storage devices 4 may vary. For example, the asynchronous copying time and the synchronous copying time vary with the type of the storing device 51, the type of the secondary copy buffer 52, and the line load between the storage devices 4.

This causes a problem in the traditional storage system 200 that synchronous copying takes a longer time than asynchronous copying, so that copying that desires to shorten the sever response time also takes a long time.

### SUMMARY

There is provided a storage device communicably connected to another storage device, the storage device including: a plurality of copy buffers of two or more types that are to store data to be transmitted to the other storage device; a first delay time measure that measures a first delay time occurring on a communication path between the storage device and the other storage device; and a copy buffer selector that selects, on the basis of a result of comparison between the largeness of the first delay time and that of a threshold, one from the plurality of copy buffers as a copy buffer that is to store the data to be transmitted to the other storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating the functional configuration of a storage system according to an example of a first embodiment;

FIG. 2 is a diagram illustrating a first example of selecting a copy buffer in an example of the first embodiment;

FIG. 3 is a diagram illustrating a second example of selecting a copy buffer in an example of the first embodiment;

FIG. 4 is a flow diagram denoting a succession of procedural steps of remote copying in an example of the first embodiment;

FIG. 5 is a flow diagram denoting a succession of detailed procedural steps of remote copying in an example of the first embodiment;

FIG. 6 is a flow diagram denoting a succession of detailed procedural steps of remote copying in an example of the first embodiment;

FIG. 7 is a flow diagram denoting a succession of detailed procedural steps of remote copying in an example of the first embodiment;

FIG. 8 is a flow diagram denoting a succession of detailed procedural steps of remote copying in an example of the first embodiment;

FIG. 9 is a flow diagram denoting a succession of detailed procedural steps of remote copying in an example of the first embodiment; and

FIG. 10 is a diagram illustrating an example of synchronous data copying in a traditional storage device.

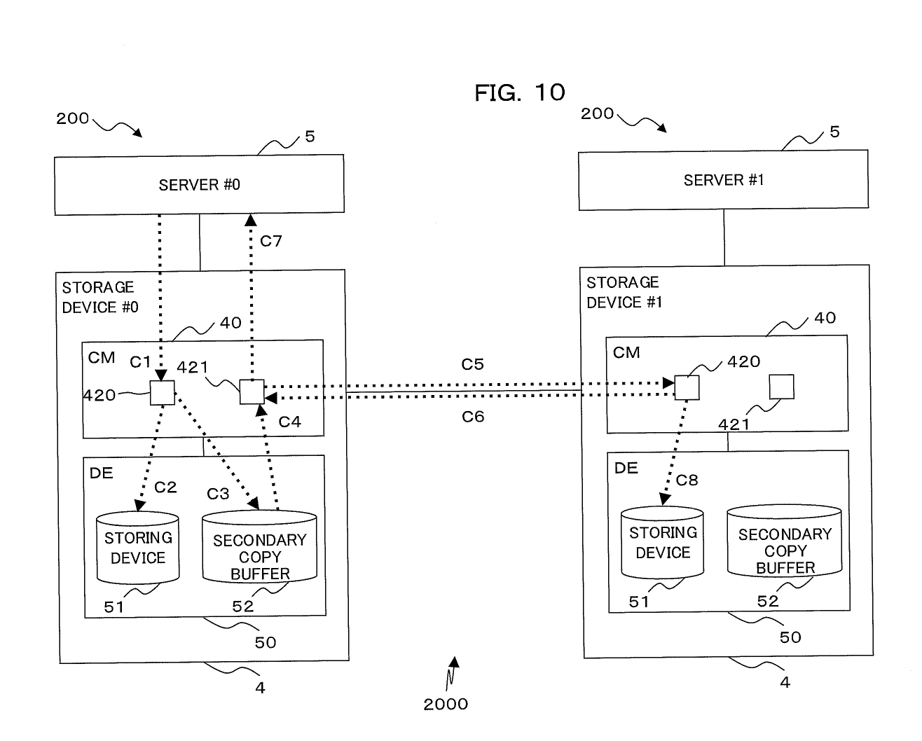

### DESCRIPTION OF EMBODIMENTS

Hereinafter, description will now be made in relation to a storage device, a controller, and a non-transitory computer-readable recording medium having stored therein a control program with reference to the accompanying drawings. However, the following embodiment is merely exemplary and has no intention to exclude various modification and application of techniques that are not explained throughout the description. In other words, various changes and modifications are suggested without departing from the spirit of the embodiment.

The drawings do not illustrate therein all the functions and elements included in the embodiment. The embodiment may include additional functions and elements to those illustrated in the accompanying drawings.

Hereinafter, like reference numbers designate similar parts and elements throughout the drawings, so repetitious description is omitted here.

### (A) First Embodiment

(A-1) System Configuration:

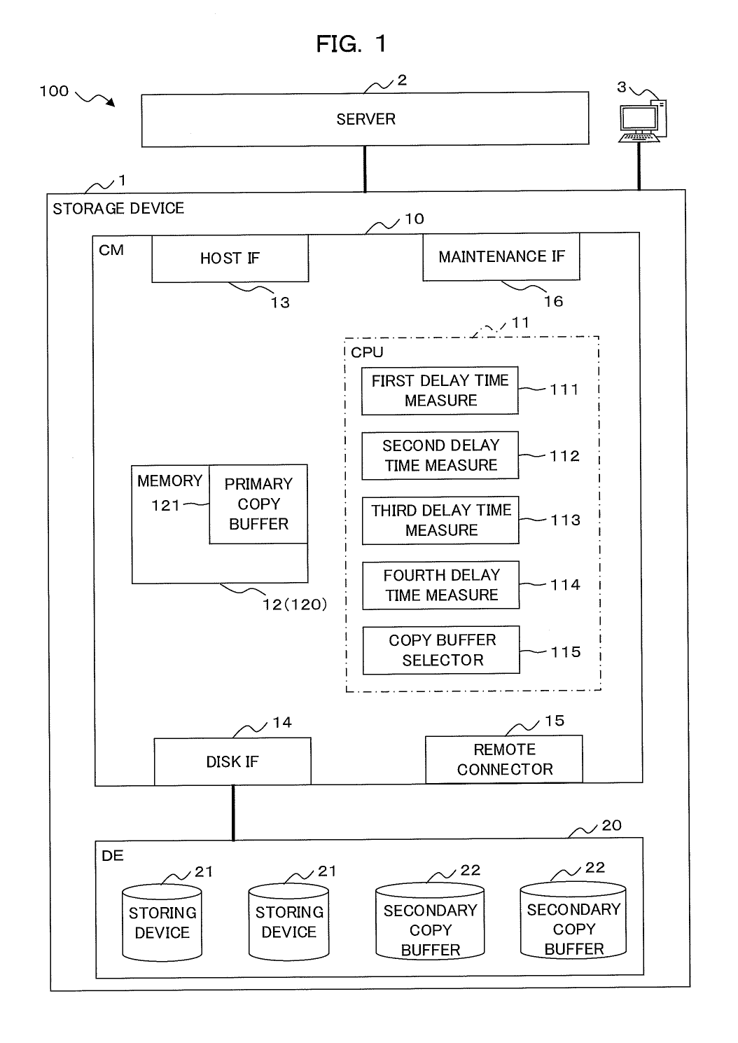

FIG. 1 is a diagram schematically illustrating the functional configuration of a storage system according to an example of the first embodiment.

A storage system 100 according to an example of the first embodiment is a tiered control system that structures a DR system. A tiered control system modifies data arrangement in a physical region in accordance with the access frequency to the corresponding to a logical volume region. Specifically, a tiered control system arranges data more frequently accessed in a storage device having a higher access speed while arranges data less frequently accessed in a storage device having a lower access speed. As illustrated in FIG. 1, the storage system 100 includes a storage device 1, a server (superordinate device) 2, and a management console 3. The storage device 1 is communicably connected to the server 2 via, for example, a Local Area Network (LAN) cable while is communicably connected to the management console 3 via, for example, also a LAN cable.

An example of the server 2 is a computer (information processing apparatus) having a server function. In the example of FIG. 1, the storage system 100 includes a server 2, but alternatively may include two or more servers 2.

The management console 3 includes non-illustrated user interfaces, such as a monitor, a keyboard, and a mouse, and controls the storage device 1 in response to the user's operation via the user interfaces.

The storage device 1 includes multiple storing devices 21 to be detailed below, and provides a storing region to the server 2. The storage device 1 redundantly disperse data to the multiple storing devices 21 using the technique of Redundant Arrays of Inexpensive Disks (RAID). The storage device 1 includes a CM (Controller Module) 10 and a DE 20, which are communicably connected to each other via, for example, a bus. In the illustrated example, the storage device 1 includes a single CM 10 but may alternatively include multiple CMs for redundancy.

The DE 20 includes multiple (two in the illustrated example) storing devices 21 and multiple (two in the illustrated example) secondary copy buffers (copy buffers) 22.

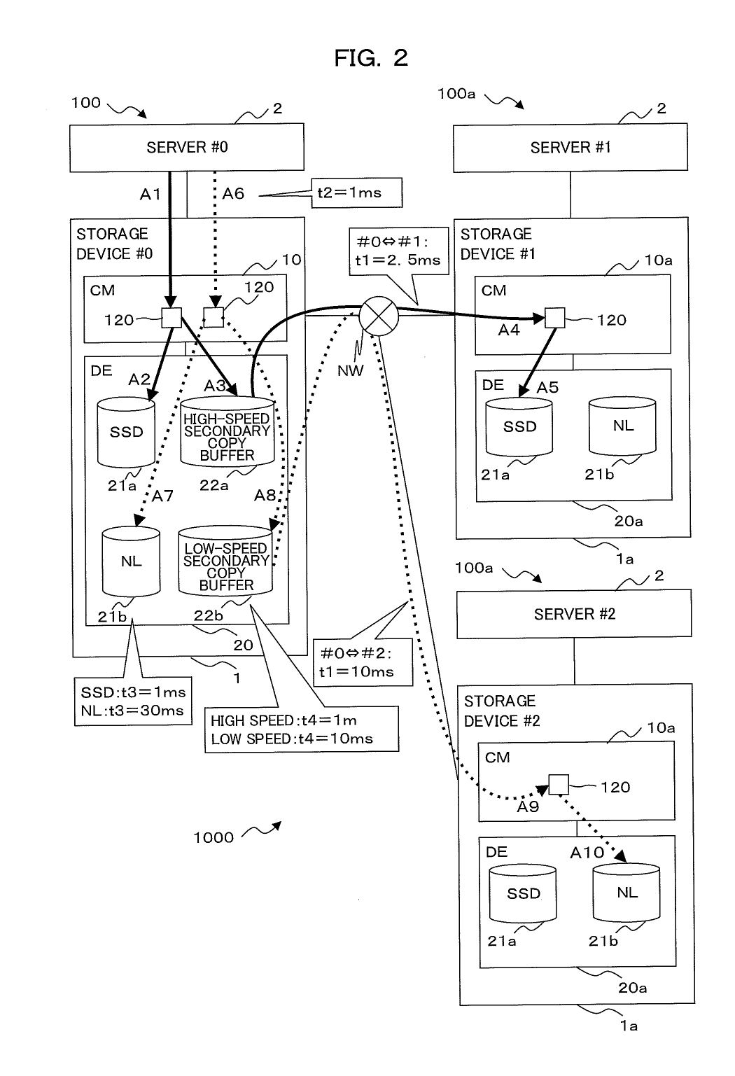

A storing device 21 is a device that readably and writably stores data therein and is exemplified by an HDD or an SSD. In an example of the first embodiment, the two storing devices illustrated are different type of storing device, and, for example, are an SSD 21a and a Near Line (NL) 21b as to be detailed below by referring to FIG. 2.

The secondary copy buffer 22 is a storing device complementary to the cache region of a cache memory 120 that is to be detailed below. In an example of the first embodiment, the two illustrated secondary copy buffers 22 are different types from each other, and are, for example, high-speed secondary copy buffer 22a and a low-speed secondary copy buffer 22b as to be detailed below by referring to FIG. 2.

The CM 10 is a controller responsible for various controls, and functions in response to a storage access command (access control signal: hereinafter called a host I/O) from the server 2. The CM 10 includes a CPU (computer) 11, a memory 12, a host interface (IF) 13, and a disk IF 14, a remote connector 15, and a maintenance IF 16.

The host IF 13 is an interface controller that communicably connects the CM 10 to the server 2, and is exemplified by a LAN card.

The disk IF 14 is an interface that communicably connects the CM 10 to the DE 20, and is exemplified by a Fiber Channel (FC) adaptor.

The remote connector 15 an interface device that connects the CM 10 to a network NW (to be detailed below with reference to FIG. 2) and that allows the CM 10 to communicate with a remote storage device 1a (to be detailed below with reference to FIG. 2) via the network NW. Examples of the remote connector 15 are various interface cards conforming to network standards such as a wired LAN, a wireless LAN, and Wireless Wide Area Network (WWAN).

The maintenance IF 16 is an interface that communicably connects the CM 10 with the management console 3, and is exemplified by a LAN card.

The memory 12 is a storing device including a Read Only Memory (ROM) and a Random Access Memory (RAM). In the ROM of the memory 12, a program such as Basic Input/Output System (BIOS) is written. The software program in the memory 12 is appropriately read and executed by the CPU 11. The RAM of the memory 12 is used as a primary recording memory (cache memory) 120 or a working memory. Furthermore, the memory 12 has a region serving as a primary copy buffer 121.

The primary copy buffer 121 is a FIFO memory that stores therein packets to be sent to or received from the other storage device 1a.

The CPU 11 is a processor that executes various controls and calculations, and achieves various functions by executing the Operating System (OS) and programs stored in the memory 12. As illustrated in FIG. 1, the CPU 11 functions as a first delay time measure 111, a second delay time measure 112, a third delay time measure 113, a fourth delay time measure 114, and a copy buffer selector 115.

The program (controlling program) that achieves the functions of the first delay time measure 111, the second delay time measure 112, the third delay time measure 113, the fourth delay time measure 114, and the copy buffer selector 115 is provided in the form of being recorded in a tangible and non-transitory computer-readable storage medium, such as a flexible disk, a CD (e.g., CD-ROM, CD-R, andCD-RW), aDVD (DVD-ROM, DVD-RAM, DVD-R, DVD+R, DVD-RW, DVD+RW, and HD DVD), a Blu-ray disk, a magnetic disk, an optical disk, and a magneto-optical disk. A computer reads the program from the recording medium using a non-illustrated medium reader and stores the read program in an internal or external storage device for future use. Alternatively, the controlling program may be recorded in a recording device (recording medium), such as a magnetic disk, an optical disk, or a magneto-optical disk, and may be provided from the recording device to the computer via a communication path.

Further alternatively, in achieving the functions of the first delay time measure 111, the second delay time measure 112, the third delay time measure 113, the fourth delay time measure 114, and the copy buffer selector 115, the program stored in the internal storage device (corresponding to the memory 12 in the first embodiment) is executed by the microprocessor (corresponding to the CPU 11 in the first embodiment) of the computer. For this purpose, the computer may read the program stored in the recording medium and execute the program.

The first delay time measure 111 measures a first delay time t1 that occurs on the communication path between the storage device 1 and the other storage device 1a (to be detailed below by referring to FIG. 2). Specifically, the first delay time measure 111 uses a first delay time table (not illustrated) in which the transmission delay time between the storage devices 1 and 1a is previously determined or the remote connector 15 to measure the first delay time t1. When a Remote Equipment Copy (REC) scheduled time comes, the first delay time measure 111 measures the first delay time t1 by reading the first delay time t1 from the first delay time table. The first delay time table is defined in terms of the distance of remote copying (i.e., the distance between the primary site and the DR site), and is previously stored in, for example, the memory 12. While a command is executed in a remote copying mode, the first delay time measure 111 measures one-way delay time as a first delay time by measuring a round-trip delay time from the start of data transmission to the other storage device 1a to the receipt of response data from the other storage device 1a using the remote connector 15.

The second delay time measure 112 measures a second delay time t2 that occurs on the communication path between the storage device 1 and the server 2. Specifically, in the cases where the storage device 1 has started and is recognized by the server 2 or immediately before the start of scheduled copying, the second delay time measure 112 measures the second delay time using the host IF 13. The measuring of the second delay time t2 immediately before the start of scheduled copying may be omitted.

Here, the I/O process between the server 2 and the storage device 1 in the fiber channel connection will now be described. Upon receipt of a command sent from the server 2, the storage device 1 reply to the server 2 with the response of the command receipt. Upon receipt of the response of the command receipt from the storage device 1, the server 2 sends data to the storage device 1. Upon receipt of the data from the server 2, the storage device 1 replies to the server 2 with the response of data receipt. Then, the server 2 receives the response of the data receipt form the storage device 1 and thereby the series of the I/O process is completed. The second delay time measure 112 measures the second delay time t2 by measuring the time taken to receive the data since the storage device 1 has sent the response of the command receipt.

The third delay time measure 113 measures a third delay time t3 that occurs in data access to the storing device 21 included in the storage device 1. Specifically, the third delay time measure 113 measures the third delay time t3 using a third delay time table (not illustrated) that previously sets an accessing time of each of the types of the storing devices constituting the RAID group that store the copied data or the disk IF 14. When the REC scheduled time comes, the third delay time measure 113 measures the third delay time t3 by reading the third delay time t3 from the third delay time table. Here, the thirddelay time table is stored in, for example, the memory 12 in advance. While a command is executed in the remote copying mode, the third delay time measure 113 measures the third delay time t3, using the disk IF 14, by measuring the time taken to forward data from a cache region (cache memory 120) to the RAID group region.

The fourth delay time measure 114 measures the fourth delay times t4 that occur data access to each of the multiple secondary copy buffers 22 of two or more types. Specifically, when the REC scheduled time comes, the fourth delay time measure 114 measures each fourth delay time t4, using the disk IF 14, by measuring the time taken to forward data from the cache memory 120 to the corresponding secondary copy buffer 22.

The first delay time measure 111, the second delay time measure 112, the third delay time measure 113, and the fourth delay time measure 114 stores the first delay time t1, the second delay time t2, the third delay time t3, and the fourth delay times t4 respectively measured into, for example, the memory 12.

The copy buffer selector 115 selects a secondary copy buffer 22 that is to store the data to be transmitted to the other storage device la among the secondary copy buffers 22 of two or more types on the basis of the result of comparison between the largeness the first delay time t1 and that of a threshold. Besides, the copy buffer selector 115 calculates the threshold based on the second delay time t2 and the third delay time t3. In other words, the copy buffer selector 115 selects a secondary copy buffer 22 that is to be used for data transmission to the other storage device 1a among the multiple secondary copy buffers 22 on the basis of the result of the comparison between an asynchronous copying time Tas and the transmission delay time (i.e., the first delay time t1) between the storage devices and la. In this manner, the copy buffer selector 115 switches a secondary copy buffer 22 to be used for data transmission to the other storage device 1a among the multiple secondary copy buffers 22.

Specifically, the copy buffer selector 115 calculates the asynchronous copying time Tas (=t2+t3) that is taken to store data received from the server 2 into the storing device 21 of the storage device 1 before and while data writing is executed. In addition, before and while data writing is executed, the copy buffer selector 115 calculates a synchronous copying time Ts (=t1+t1+t2+t4) that is taken to copy data received from the server 2 into a storing device 21 of the storage device 1a and confirm the completion of the copying afterwards.

Then, the copy buffer selector 115 determines whether the relationship Tast1×2 is satisfied. As the above, the first delay time t1 is a one-way delay time occurring on the communication path between the storage device 1 and the other storage device a. During the time t1×2 corresponding to the time that the storage device 1 takes to receive response data from the storage device 1a since the storage device 1 has transmitted data to the storage device 1a, the storage device 1 does not reply to the server 2 with the completion of the synchronous copying. For this reason, the copy buffer selector 115 determines whether the relationship Tas≦t1×2 is satisfied.

In cases where the relationship Tas≦t1×2 is satisfied, the copy buffer selector 115 selects a secondary copy buffer 22 (e.g., the high-speed secondary copy buffer 22a to be detailed below with reference to FIG. 2) having a high processing speed among the secondary copy buffers 22 of two or more types. In contrast, in cases where the relationship Tas>t1×2 is satisfied, the copy buffer selector 115 selects a secondary copy buffer 22 (e.g., the low-speed secondary copy buffer 22b to be detailed below with reference to FIG. 2) having a low processing speed among the secondary copy buffers 22 of two or more types. Here, in cases where the storage device 1 includes multiple secondary copy buffers 22 each having a low processing speed, the copy buffer selector 115 determines, in sequence from the secondary copy buffer 22 having the lowest processing speed, whether the secondary copy buffer 22 satisfies the relationship Tas≧Ts, and selects the secondary copy buffer 22 that satisfies the relationship Tas≧Ts first.

This means that, in cases where the sum of the second delay time t2 and the third delay time t3 is equal to or lower than the twice the first delay time t1, the copy buffer selector 115 selects the secondary copy buffer 22 having the smallest fourth delay time t4 among multiple secondary copy buffers 22 of two or more types. In other words, in cases where the asynchronous copying time Tas is equal to or shorter than the time for round-trip data transmission between the storage devices 1 and la, the copy buffer selector 115 selects the secondary copy buffer 22 having the highest processing speed.

In contrast, in cases where the sum of the second delay time t2 and the third delay time t3 is larger than the twice the first delay time t1, the copy buffer selector 115 selects the secondary copy buffer 22 having a fourth delay time t4 that allows the third delay time t3 to be equal to or larger than the sum of the fourth delay time t4 and the twice the first delay time t1 among the multiple secondary copy buffers 22 of two or more types. In other words, in cases where the asynchronous copying time Tas is longer than the time for round-trip data transmission between the storage devices 1 and la, the copy buffer selector 115 selects a secondary copy buffer 22 having a relatively low processing speed.

Further, the copy buffer selector 115 selects the secondary copy buffer 22 having a fourth delay time t4 that allows the third delay time t3 to be the closest to the sum of the fourth delay time t4 and the twice the first delay time t1 among the multiple secondary copy buffers 22 of two or more types.

FIG. 2 is a diagram illustrating a first example of selecting a copy buffer according to an example of the first embodiment.

A storage network 1000 of FIG. 2 includes multiple (three in the drawing) storage systems 100 and 100a.

Each storage system 100a may be the same as the traditional storage system 200 or the same as the storage system 100 of the first embodiment. The storage systems 100a includes a storage device (storage device #1 or #2) 1a and a server (servers #1 or #2) 2. Each storage device 1a includes a CM 10a and a DE 20a.

In the illustration of the storage system 100, only the storage devices (storage device #0) 1 and the server (server #0) 2 appear while the management console 3 is omitted for simplification. Likewise, with respect to the CMs 10 and 10a respectively included in the storage devices 1 and la, the cache memories 120 are only illustrated while illustration of the remaining functional configuration is omitted for simplification. For easiness of the description, two cache memories 120 are illustrated in the CM 10.

In the example of FIG. 2, the DE 20 of the storage device 1 includes an SSD 21a, a NL 21b, the high-speed secondary copy buffer 22a, and the low-speed secondary copy buffer 22b while the DE 20a of each storage device 1a includes an SSD 21a and a NL 21b.

Hereinafter, when one of the multiple storage devices needs to be specified, the storage device is represented by “storage device #0”, “storage device #1”, or “storage device #2”, while an arbitrary storage device is represented by “storage device 1, 1a”. Likewise, when one of the multiple servers needs to be specified, the server is represented by “server #0”, “server #1”, or “server #2”, while an arbitrary server is represented by “server 2”.

As illustrated in FIG. 2, the storage devices #0, #1, and #2 are connected to one another via a network NW.

In the example of FIG. 2, the first delay time measure 111 measures 2.5 ms (millisecond) for the first delay time t1 between the storage device #0 and the storage device #1, and measures 10 ms for the first delay time t1 between the storage device #0 and the storage device #2 . The second delay time measure 112 measures 1 ms for the second delay time t2. The third delay time measure 113 measures 1 ms for the third delay time t3 of the SSD 21a, and measures 30 ms for the third delay time t3 of the NL 21b. The fourth delay time measure 114 measures 1 ms for the fourth delay time t4 of the high-speed secondary copy buffer 22a and measures 10 ms for the fourth delay time t4 of the low-speed secondary copy buffer 22b.

First of all, description will now be made in relation to the selecting for a copy buffer when data is to be stored into the SSD 21a of the storage device #0 and the SSD 21a of the storage device #1.

The copy buffer selector 115 calculates the asynchronous copying time Tas taken to store data into the SSD 21a to be Tas=t2+t3=1+1=2 ms. The copy buffer selector 115 determines whether the relationship Tas≦t1×2 is satisfied. In the example of FIG. 2, since the twice the first delay time t1 is t1×2=2.5×2=5 ms, the relationship Tas≦t1×2 is satisfied. Consequently, the copy buffer selector 115 selects the high-speed secondary copy buffer 22a having a higher processing speed among the multiple secondary copy buffers 22 of two or more types. The synchronous copying using the selected high-speed secondary copy buffer 22a takes a synchronous copying time Ts=t1+t1+t2+t4=2.5+2.5+1+1=7 ms. The calculated synchronous copying time Ts is closer to the asynchronous copying time Tas than a synchronous copying time that the synchronous copying using the low-speed secondary copy buffer 22b not being selected takes.

The server #0 transmits data to be written into the SSD 21a to the storage device #0 and the CM 10 temporarily stores the received data in the cache memory 120 (see Arrow A1).

The CM 10 stores the data temporarily stored in the cache memory 120 into the SSD 21a (see Arrow A2).

The CM 10 temporarily stores data output from the cache memory 120, as data to be stored into the storage device #1, in the high-speed secondary copy buffer 22a selected by the copy buffer selector 115 (see Arrow A3).

The CM 10 reads the data temporarily stored in the high-speed secondary copy buffer 22a and temporarily stores the read data in the primary copy buffer 121, which does not appear in FIG. 2. The CM 10 reads the data temporarily stored in the primary copy buffer 121 and transmits the read data to the storage device #1. The CM 10a of the storage device #1 temporarily stores the received data in the cache memory 120 (see Arrow A4).

The CM 10a of the storage device #1 stores the data temporarily stored in the cache memory 120 into the SSD 21a (see Arrow A5).

Next, description will now be made in relation to selecting a copy buffer when the data is to be stored into the NL 21b of the storage device #0 and the NL 21b of the storage device #2 with reference to FIG. 2.

The copy buffer selector 115 calculates the asynchronous copying time Tas taken to store data into the NL 21b to be Tas=t2+t3=1+30=31 ms. The copy buffer selector 115 determines whether the relationship Tas≦t1×2 is satisfied. In the example of FIG. 2, since the twice the first delay time t1 is t1×2=10×2=20 ms, the relationship Tas≦t1×2 isnot satisfied. Consequently, the copy buffer selector 115 selects the low-speed secondary copy buffer 22b having a lower processing speed among the multiple secondary copy buffers 22 of two or more types. The synchronous copying using the selected low-speed secondary copy buffer 22b takes a synchronous copying time

Ts=t1+t1+t2+t4=10+10+1+10=31 ms. The calculated synchronous copying time Ts is closer to (the same as) the asynchronous copying time Tas than a synchronous copying time that the synchronous copying using the high-speed secondary copy buffer 22a not being selected takes.

The server #0 transmits data to be written into the NL 21b to the storage device #0 and the CM 10 temporarily stores the received data in the cache memory 120 (see Arrow A6).

The CM 10 stores the data temporarily stored in the cache memory 120 into the NL 21b (see Arrow A7).

The CM 10 temporarily stores data output from the cache memory 120, as data to be stored into the storage device #2, in the low-speed secondary copy buffer 22b selected by the copy buffer selector 115 (see Arrow A8).

The CM 10 reads the data temporarily stored in the low-speed secondary copy buffer 22b and temporarily stores the read data into the primary copy buffer 121, which does not appear in FIG. 2. The CM 10 reads the data temporarily stored in the primary copy buffer 121 and transmits the read data to the storage device #2. The CM 10a of the storage device #2 temporarily stores the received data in the cache memory 120 (see Arrow A9).

The CM 10a of the storage device #2 stores the data temporarily stored in the cache memory 120 into the NL 21b (see Arrow A10).

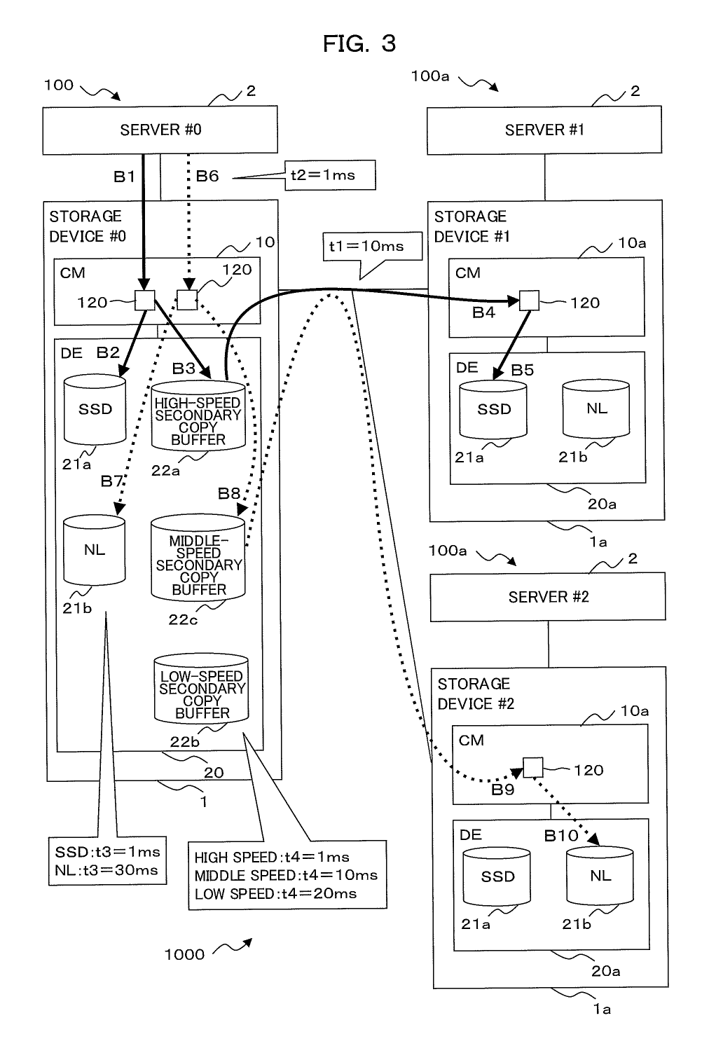

FIG. 3 is a diagram illustrating a second example of selecting a copy buffer according to an example of the first embodiment.

A storage network 1000 of FIG. 3 includes multiple (three in the drawing) storage system 100 and 100a likewise the storage network 1000 of FIG. 2. In addition to the SSD 21a, the NL 21b, the high-speed secondary copy buffer 22a, and the low-speed secondary copy buffer 22b included in the DE 20 of the storage device #0 of FIG. 2, the DE 20 of the storage device #0 of FIG. 3 includes a middle-speed secondary copy buffer 22c. Differently from the storage network 1000 of FIG. 2, the storage device #1 and the storage device #2 are communicably connected to the storage device #0 via the same line.

In the example of FIG. 3, the first delay time measure 111 measures 10 ms (millisecond) for the first delay time t1 between the storage device #0 and the storage device #1, and measures 10 ms for the first delay time t1 between the storage device #0 and the storage device #2. The second delay time measure 112 measures 1 ms for the second delay time t2. The third delay time measure 113 measures 1 ms for the third delay time t3 of the SSD 21a, and measures 30 ms for the third delay time t3 of the NL 21b. The fourth delay time measure 114 measures 1 ms for the fourth delay time t4 of the high-speed secondary copy buffer 22a, measures 10 ms for the fourth delay time t4 of the middle-speed secondary copy buffer 22c, and measures 20 ms for the fourth delay time t4 of the low-speed secondary copy buffer 22b.

First of all, description will now be made in relation to the selecting for a copy buffer when data is to be stored in the SSD 21a of the storage device #0 and the SSD 21a of the storage device #1.

The copy buffer selector 115 calculates the asynchronous copying time Tas taken to store data into the SSD 21a to be Tas=t2+t3=1+1=2 ms. The copybuffer selector 115 determines whether the relationship Tas≦t1×2 is satisfied. In the example of FIG. 3, since the twice the first delay time t1 is t1×2=10×2=20 ms, the relationship Tas≦t1×2 is satisfied. Consequently, the copy buffer selector 115 selects the high-speed secondary copy buffer 22a having a higher processing speed among the multiple secondary copy buffers 22 of two or more types. The synchronous copying using the selected high-speed secondary copy buffer 22a takes a synchronous copying time Ts=t1+t1+t2+t4=10+10+1+1=22 ms. The calculated synchronous copying time Ts is closer to the asynchronous copying time Tas than a synchronous copying time that the synchronous copying using the low-speed secondary copy buffer 22b or the middle-speed secondary copy buffer 22c not being selected takes.

The server #0 transmits data to be written into the SSD 21a to the storage device #0 and the CM 10 temporarily stores the received data in the cache memory 120 (see Arrow B1).

The CM 10 stores the data temporarily stored in the cache memory 120 into the SSD 21a (see Arrow B2).

The CM 10 temporarily stores data output from the cache memory 120, as data to be stored into the storage device #1, into the high-speed secondary copy buffer 22a selected by the copy buffer selector 115 (see Arrow B3).

The CM 10 reads the data temporarily stored in the high-speed secondary copy buffer 22a and temporarily stores the read data into the primary copy buffer 121, which does not appear in FIG. 3. The CM 10 reads the data temporarily stored in the primary copy buffer 121 and transmits the read data to the storage device #1. The CM 10a of the storage device #1 temporarily stores the received data in the cache memory 120 (see Arrow B4).

The CM 10a of the storage device #1 stores the data temporarily stored in the cache memory 120 into the SSD 21a (see Arrow B5).

Next, description will now be made in relation to selecting of a copy buffer when data is to be stored into the NL 21b of the storage device #0 and the NL 21b of the storage device #2 with reference to FIG. 3.

The copy buffer selector 115 calculates the asynchronous copying time Tas taken to store data into the NL 21b to be Tas=t2+t3=1+30=31 ms. The copy buffer selector 115 determines whether the relationship Tas≦t1×2 is satisfied. In the example of FIG. 3, since the twice the first delay time t1 is t1×2=10×2=20 ms, the relationship Tas≦t1×2 is not satisfied. Consequently, the copy buffer selector 115 determines, in sequence from the secondary copy buffer 22 having the lowest processing speed, whether the secondary copy buffer 22 satisfies the relationship Tas≧Ts, and selects a secondary copy buffer 22 that satisfies the relationship Tas≧Ts first. The low-speed secondary copy buffer 22b having the lowest processing speed has a synchronous copying time Ts=t1+t1+t2+t4=10+10+1+20=41 ms, which does not satisfy the relationship Tas≧Ts. The middle-speed secondary copy buffer 22c having the second lowest processing speed has a synchronous copying time Ts=t1+t1+t2+t4=10+10+1+10=31 ms, which satisfies the relationship Tas≧Ts. The calculated synchronous copying time Ts is closer to (the same as) the asynchronous copying time Tas than a synchronous copying time that the synchronous copying using the high-speed secondary copy buffer 22a or the low-speed secondary copy buffer 2 2b not being selected takes. Therefore, the copy buffer selector 115 selects the middle-speed secondary copy buffer 22c.

The server #0 transmits data to be written into the NL 21b to the storage device #0 and the CM 10 temporarily stores the received data in the cache memory 120 (see Arrow B6).

The CM 10 stores the data temporarily stored in the cache memory 120 into the NL 21b (see Arrow B7).

The CM 10 temporarily stores data output from the cache memory 120, as data to be stored into the storage device #2, into the middle-speed secondary copy buffer 22c selected by the copy buffer selector 115 (see Arrow B8).

The CM 10 reads the data temporarily stored in the middle-speed secondary copy buffer 22c and temporarily stores the read data in the primary copy buffer 121, which does not appear in FIG. 3. The CM 10 reads the data temporarily stored in the primary copy buffer 121 and transmits the read data to the storage device #2.

The CM 10a of the storage device #2 temporarily stores the received data in the cache memory 120 (see Arrow B9).

The CM 10a of the storage device #2 stores the data temporarily stored in the cache memory 120 into the NL 21b (see Arrow B10).

(A-2) Operation:

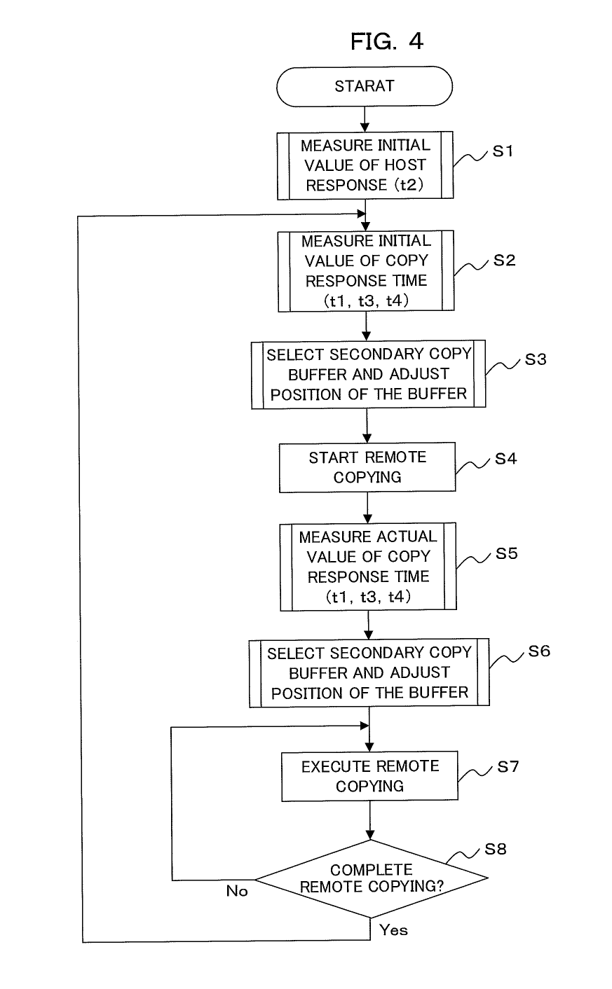

The process of remote copying in the storage device of an example of the first embodiment having the above configuration will now be described along the flow diagram FIG. 4 (steps S1-S8).

With reference to the flow diagram FIG. 4, the operation in the storage device #0 included in the storage network 1000 of FIG. 2 or FIG. 3 will now be detailed.

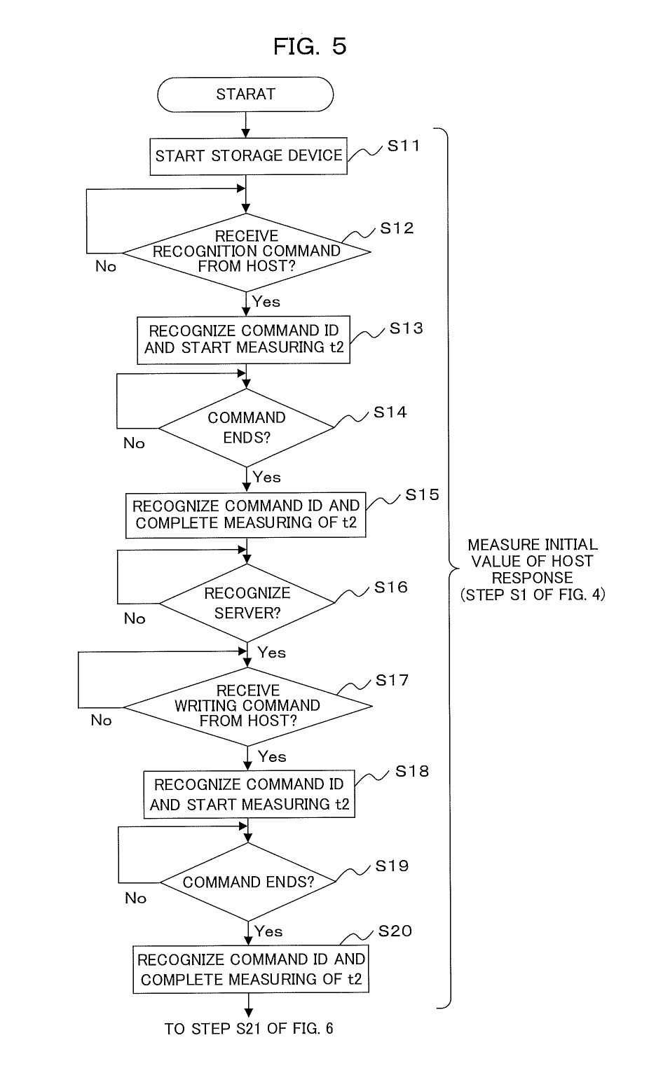

The second delay time measure 112 measures the second delay time t2, which is regarded as the initial value of the host response (step Si). An example of the initial value of the host response will be detailed below along steps S11-S20 of FIG. 5.

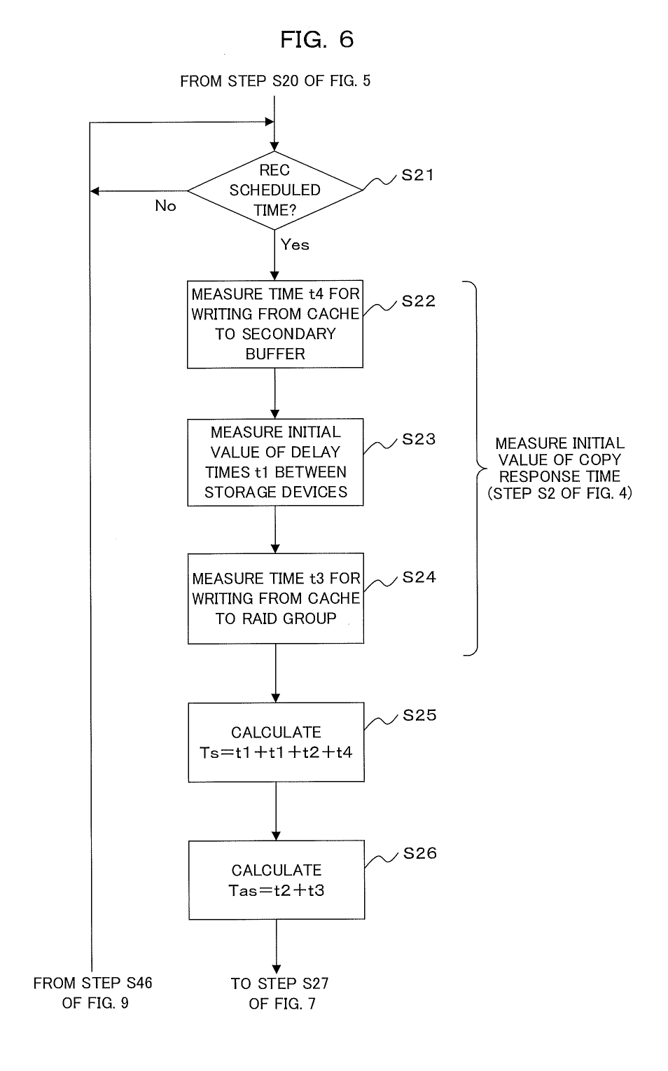

The first delay time measure 111, the third delay time measure 113, and the fourth delay time measure 114 measure the first delay time t1, the third delay time t3, and the fourth delay times t4, respectively, which are regarded as the initial values of the copy response times (step S2). An example of the initial values of the copy response times will be detailed below along steps S22-S24 of FIG. 6.

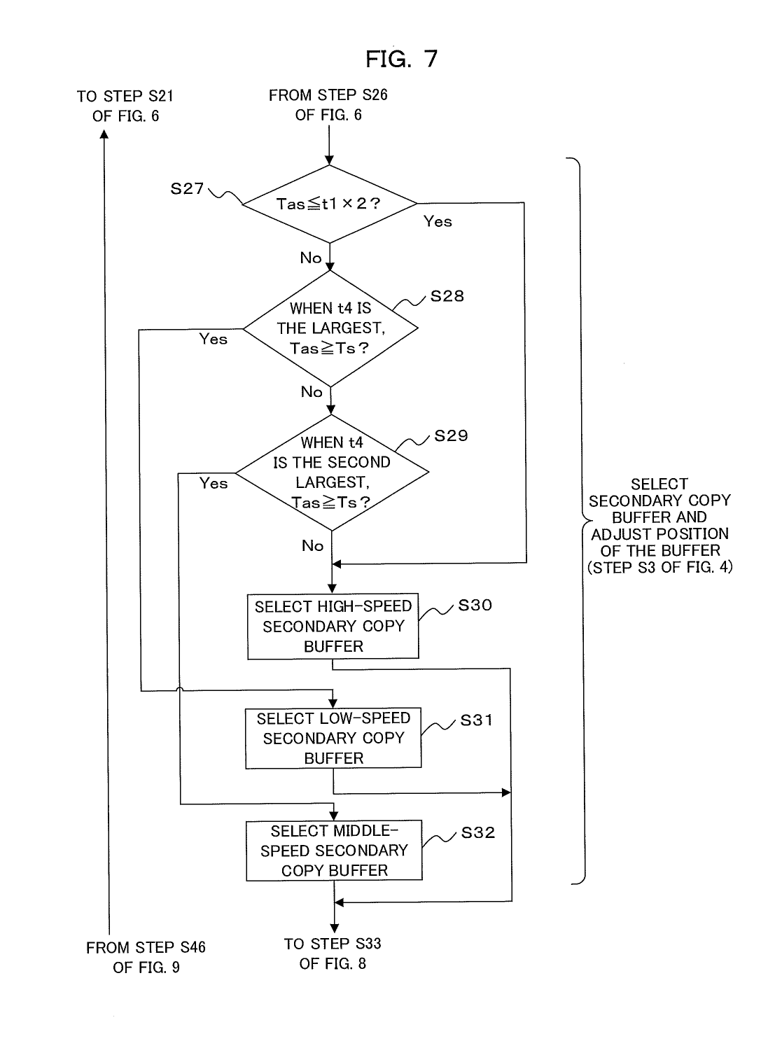

On the basis of the initial value of the host response and the initial values of the copy response times, the copy buffer selector 115 selects a secondary copy buffer 22 and adjusts the position of the selected secondary copy buffer (step S3). An example of the selecting of a secondary copy buffer 22 and the adjusting the position of the selected buffer 22 will be detailed below along steps S27-S32 of FIG. 7.

The CM 10 of the storage device 1 starts remote copying (step S4).

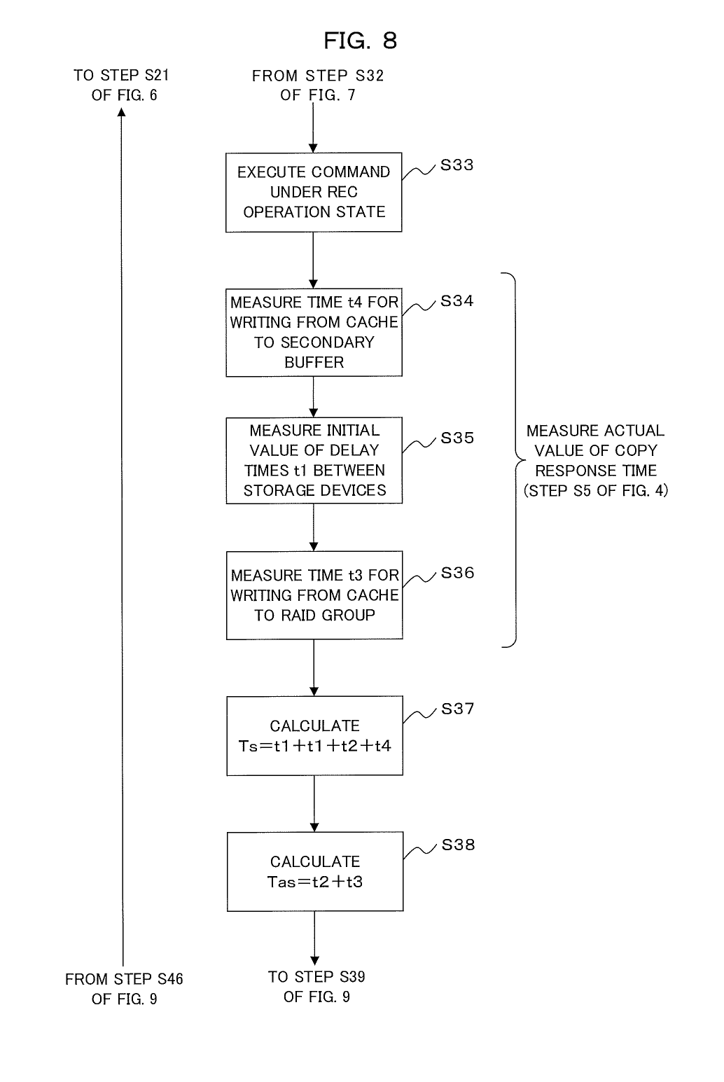

The first delay time measure 111, the third delay time measure 113, and the fourth delay time measure 114 measure the first delay time t1, the third delay time t3, and the fourth delay times t4, respectively, which are regarded as actual values of the copy response times (step S5). An example of the actual values of the copy response times will be detailed along steps S34-S36 of FIG. 8.

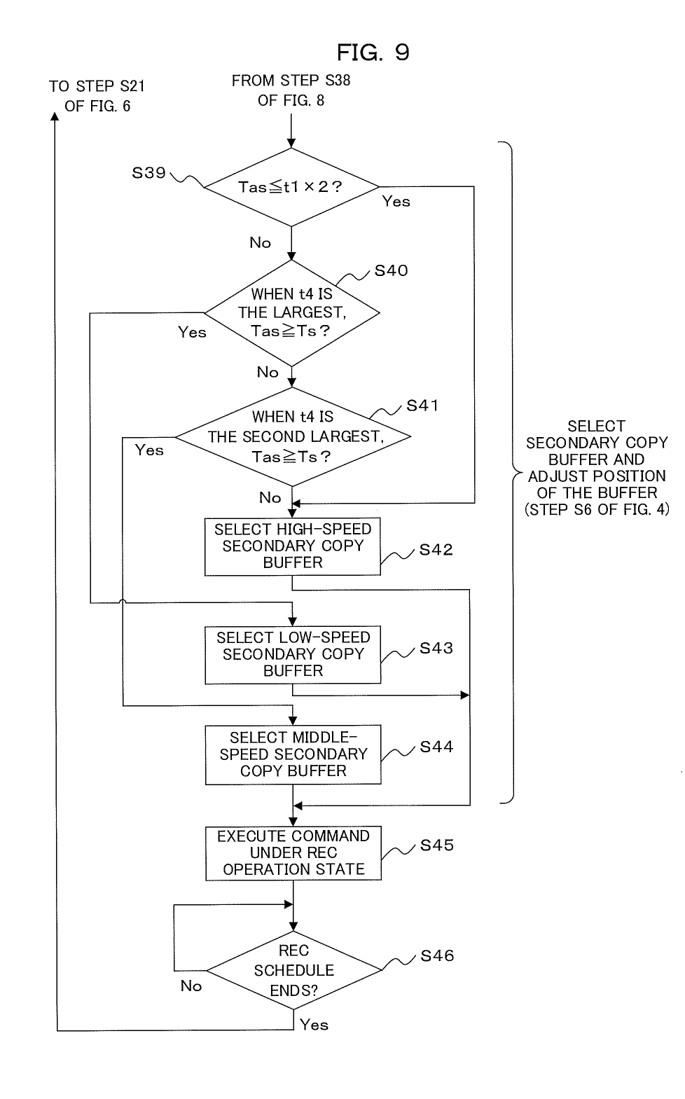

On the basis of the initial value of the host response and the actual values of the copy response times, the copy buffer selector 115 selects a secondary copy buffer 22 and adjusts the position of the selected secondary copy buffer (step S6). An example of the selecting of a secondary copy buffer 22 and the adjusting the position of the buffer 22 will be detailed below along steps S39-S44 of FIG. 9.

The CM 10 of the storage device 1 executes remote copying (step S7).

The CM 10 of the storage device 1 determines whether the remote copying is completed (step S8).

In cases where the remote copying is not completed yet (see No route in step S8), the procedure returns to step S7.

In contrast, in cases where the remote copying is completed yet (see Yes route in step S8), the procedure returns to step S2.

Next, a detailed example of remote copying in the storage device of an example of the first embodiment will now be described by referring to flow diagrams (steps S11-S46) of FIGS. 5-9. FIG. 5 denotes steps S11-S2; FIG. 6 denotes steps S21-S26; FIG. 7 denotes steps S27-S32; FIG. 8 denotes steps S33-S38; and FIG. 9 denotes steps S39-S46.

The flow diagrams of FIGS. 5-9 describes a detailed example of the operation of the storage device #0 included in the storage network 1000 of FIG. 3.

When the storage device #0 starts (step S11 of FIG. 5), the second delay time measure 112 determines whether a recognition command of the storage device 1 is received from the server #0 (host) (step S12 of FIG. 5).

In cases where the recognition command is not received from the host (see No route in step S12 of the FIG. 5), the process returns to step S12 of FIG. 5 and is on standby.

In contrast, in cases where the recognition command is received from the host (see Yes route in step S12 of the FIG. 5), the second delay time measure 112 recognizes the command ID and starts measuring the second delay time t2 (step S13 of FIG. 5).

The second delay time measure 112 determines whether the command ends (step S14 of FIG. 5).

In cases where the command does not end yet (see No route in step S14 of FIG. 5), the process returns to step S14 of FIG. 5 and the second delay time measure 112 continues to measure the second delay time t2.

In contrast, in cases where the command ends (see Yes route in step S14 of FIG. 5), the second delay time measure 112 recognizes the command ID and completes measuring of the second delay time t2 (step S15 of FIG. 5).

The second delay time measure 112 determines whether the second delay time measure 112 recognizes the server #0 (step S16 in FIG. 5).

In cases where the second delay time measure 112 does not successfully recognize the server #0 (see No route in step S16 of FIG. 5), the process returns to step S16 in FIG. 5 and is on standby until successfully recognizing the server #0.

In contrast, in cases where the second delay time measure 112 successfully recognizes the server #0 (see Yes route in step S16 of FIG. 5), the second delay time measure 112 determines whether the second delay time measure 112 receives a writing command from the server #0 (host) (step S17 of FIG.5).

In cases where, the second delay time measure 112 does not receive the writing command from the host (see No route in step S17 of FIG. 5), the process returns to step S17 in FIG. 5 and is on standby until receiving a writing command from the host.

In contrast, in cases where second delay time measure 112 receives the writing command from the host (see Yes route in step S17 of FIG. 5), the second delay time measure 112 recognizes the command ID and starts measuring the second delay time t2 (step S18 of FIG. 5).

The second delay time measure 112 determines whether the command ends (step S19 in FIG. 5).

In cases where the command does not end yet (see No route in step S19 of FIG. 5), the process returns to step S19 in FIG. 5 and the second delay time measure 112 continues to measure the second delay time t2.

In contrast, in cases where the command ends (see Yes route in step S19 of FIG. 5), the second delay time measure 112 recognizes the command ID and completes the measuring of the second delay time t2 (step S20 of FIG. 5).

The measuring of the initial value of the host response of step S1 of FIG. 4 is completed by carrying out steps S11-S20 of FIG. 5.

In the example of steps S11-S20 of FIG. 5, the second delay time measure 112 measures the second delay time t2 in steps S13-S15 and also in steps S18-S20. Hereinafter, the copy buffer selector 115 selects a secondary copy buffer 22 using the second delay time t2 measured in steps S18-S20 of FIG. 5.

The CM 10 of the storage device #0 determines whether the Remote copying (REC) scheduled time comes (step S21 of FIG. 6).

In cases where the REC scheduled time does not come yet (see No route in step S21 of FIG. 6), the process returns to step S21 of FIG. 6 and is on standby until the REC scheduled time comes.

In cases where the REC scheduled time comes (see Yes route in step S21 of FIG. 6), the fourth delay time measure 114 measures the time taken to write data from the cache memory 120 into the secondary copy buffer 22 as the fourth delay time t4 (step S22 in FIG. 6).

The first delay time measure 111 measures the first delay times t1 that occur on the transmission paths between the storage device #0 and the storage device #1 and between the storage device #0 and the storage device #2 (step S23 of FIG. 6).

The third delay time measure 113 measures the time taken to write data from the cache memory 120 from each of the storing devices 21 constituting the RAID group as the third delay time t3 (step S24 of FIG. 6).

Execution of the above steps S22-S24 of FIG. 6 completes the measuring of the initial value of the copy response times of step S2 of FIG. 4.

The copy buffer selector 115 calculates the synchronous copying time Ts=t1+t1+t2+t4 (Step S25 of FIG. 6).

The copy buffer selector 115 calculates the asynchronous copying time Tas=t2+t3 (step S26 of FIG. 6).

The copy buffer selector 115 determines whether the relationship Tas≦t1×2 is satisfied (step S27 of FIG. 7).

In cases where the relationship Tas≦t1×2 is satisfied (see Yes route in step S27 of FIG. 7), the copy buffer selector 115 selects the high-speed secondary copy buffer 22a (step S30 of FIG. 7) and the procedure moves to step S33 of FIG. 8.

In contrast, in cases where the relationship Tas≦t1×2 is not satisfied (see No route in step S27 of FIG. 7), the copy buffer selector 115 determines whether the largest fourth delay time t4 satisfies the relationship Tas≧Ts (step S28 of FIG. 7).

In cases where the largest fourth delay time t4 satisfies the relationship Tas≧Ts (see Yes route in step S28 of FIG. 7), the copy buffer selector 115 selects the low-speed secondary copy buffer 22b (step S31 of FIG. 7) and the procedure moves to step S33 of FIG. 8.

In cases where the largest fourth delay time t4 does not satisfy the relationship Tas≧Ts (see No route in step S28 of FIG. 7), the copy buffer selector 115 determines whether the second-largest fourth delay time t4 satisfies the relationship Tas≧Ts (step S29 of FIG. 7).

In cases where the second-largest fourth delay time t4 satisfies the relationship Tas≧Ts (Yes route in step S29 of FIG. 7), the copy buffer selector 115 selects the middle-speed secondary copy buffer 22c (step S32) and the procedure moves to step S33 of FIG. 8.

In cases where the second-largest fourth delay time t4 does not satisfy the relationship Tas≧Ts (No route in step S29 of FIG. 7), the procedure moves to step S30.

Execution of the above steps S27-S32 of FIG. 7 completes the selecting a secondary copy buffer and adjusting the position of the selected buffer of step S3 of FIG. 4.

The CM 10 of the storage device #0 executes the command under the REC operation state (step S33 of FIG. 8).

The fourth delay time measure 114 measures the time taken to write data from the cache memory 120 into the secondary copy buffer 22 as the fourth delay time t4 (step S34 of FIG. 8).

The first delay time measure 111 measures the first delay times t1 that occur on the transmission paths between the storage device #0 and the storage device #1 and between the storage device #0 and the storage device #2 (step S35 of FIG. 8).

The third delay time measure 113 measures the time taken to write data from the cache memory 120 from each of the storing devices 21 constituting the RAID group as the third delay time t3 (step S36 of FIG. 8).

Execution of the above steps S34-S36 of FIG. 8 completes the measuring the actual value of the copy response times of step S5 in FIG. 4. After that, the copy buffer selector 115 selects a secondary copy buffer 22 in steps S34-36 of FIG. 8 using the fourth delay times t4, the first delay time t1, and the third delay times t3 measured by the fourth delay time measure 114, the first delay time measure 111, and the third delay time measure 113, respectively.

The copy buffer selector 115 calculates the synchronous copying time Ts=t1+t1+t2+t4 (step S37 of FIG. 8).

The copy buffer selector 115 calculates the asynchronous copying time Tas=t2+t3 (step S38 of FIG. 8).

The copy buffer selector 115 determines whether the relationship Tas≦t1×2 is satisfied (step S39 of FIG. 9).

In cases where the relationship Tas≦t1×2 is satisfied (see Yes route in step S39 of FIG. 9), the copy buffer selector 115 selects the high-speed secondary copy buffer 22a (step S42 of FIG. 9) and the procedure moves to step S45 of FIG. 9.

In contrast, in cases where the relationship Tas≦t1×2 is not satisfied (see No route in step S39 of FIG. 9), the copy buffer selector 115 determines whether the largest fourth delay time t4 satisfies the relationship Tas≧Ts (step S40 of FIG. 9).

In cases where the largest fourth delay time t4 satisfies the relationship Tas≧Ts (see Yes route in step S40 of FIG. 9), the copy buffer selector 115 selects the low-speed secondary copy buffer 22b (step S43 of FIG. 9) and the procedure moves to step S45 of FIG. 9.

In cases where the largest fourth delay time t4 does not satisfy the relationship Tas≧Ts (see No route in step S40 of FIG. 9), the copy buffer selector 115 determines whether the second-largest fourth delay time t4 satisfies the relationship Tas≧Ts (step S41 of FIG. 9).

In cases where the second-largest fourth delay time t4 satisfies the relationship Tas≧Ts (Yes route in step S41 of FIG. 9), the copy buffer selector 115 selects the middle-speed secondary copy buffer 22c (step S44) and the procedure moves to step S45 of FIG. 9.

In cases where the second-largest fourth delay time t4 does not satisfy the relationship Tas≧Ts (No route in step S41 of FIG. 9), the procedure moves to step S42 of FIG. 9.

Execution of the above steps S39-S44 of FIG. 9 completes the selecting of a secondary copy buffer 22 and adjusting of the position of the selected buffer of step S6 of FIG. 4.

The CM 10 of the storage device #0 executes the command under the REC operation state (step S45 of FIG. 9).

The CM 10 of the storage device #0 determines whether the REC schedule ends (step S46 of FIG. 9).

In cases where the REC schedule does not end (No route in step S46), the procedure returns to step S46 and continues to execute the command.

In contrast, in cases where the REC schedule ends (see Yes route in step S46 of FIG. 9), the procedure returns to step S21 of FIG. 6.

(A-3) Effects:

As described above, the storage device 1 according to an example of the first embodiment provides the following effects.

The copy buffer selector 115 selects a secondary copy buffer 22 that is to store therein data to be transmitted to the other storage device la among the multiple secondary copy buffers 22 of two or more types on the basis of the result of comparison between the first delay time t1 measured by the first delay time measure 111 and the threshold. This makes it possible to optimize the time for the synchronous data copying.

In cases where the sum of the second delay time t2 and the third delay time t3 is equal to or smaller than the twice the first delay time t1, the copy buffer selector 115 selects the secondary copy buffer 22 having the smallest fourth delay time t4 among multiple secondary copy buffers 22 of two or more types. Thereby, in cases where the asynchronous copying time Tas is equal to or less than the synchronous copying time Ts, the data destined for the storage device 1a is stored into, for example, the high-speed secondary copy buffer 22a, so that the server response time in synchronous data copying can be shortened.

In cases where the sum of the second delay time t2 and the third delay time t3 is larger than the twice the first delay time t1, the copy buffer selector 115 selects the secondary copy buffer 22 having a fourth delay time t4 that allows the third delay time t3 to be equal to or larger than the sum of the fourth delay time t4 and the twice the first delay time t1 among the multiple secondary copy buffers 22 of two or more types. Thereby, in cases where the asynchronous copying time Tas is larger than the synchronous copying time Ts, the data destined for the storage device 1a is stored in, for example, the low-speed secondary copy buffer 22b, so that the load on the high-speed secondary copy buffer 22a can be reduced.

The copy buffer selector 115 selects the secondary copy buffer 22 having a fourth delay time t4 that allows the third delay time t3 to be the closest to the sum of the fourth delay time t4 and the twice the first delay time t1 among the multiple secondary copy buffers 22 of two or more types. Thereby, the synchronous copying time Ts is allowed to be as close to the asynchronous copying time Tas as possible, so that the time for the synchronous data copying can be optimized.

Before and during data writing, the measuring of the first delay time t1 by the first delay time measure 111 and the selecting of the secondary copy buffer 22 by the copy buffer selector 115 are repeatedly carried out. This makes it possible to select an appropriate secondary copy buffer 22 even when load on the communication paths fluctuates after the data writing is started.

Here, the storage network 1000 that connects the copy-source storage device #0 with the copy-destination storage devices #1, #2 via respective different lines described in the above by referring to FIG. 2 has the following restrictions.

(1) The first delay times t1 occurring on the respective communication paths are different with the copy-destination storage devices la.

(2) The type of storing devices 21 to store therein the same data may be different between the copy-source storage device 1 and the copy-destination storage device 1a, which has a possibility that the upper limit of the response time to the server 2 may be different with the type of storing device 21.

The storage network 1000 that connects the copy-source storage device #0 with the copy-destination storage devices #1, #2 via the same lines described by referring to FIG. 3 also has the above restriction (2).

According to the storage device 1 of the first embodiment, the copy buffer selector 115 selects an appropriate secondary copy buffer even under the presence of the above restrictions (1) and (2), and consequently, it is possible to shorten the time for copying which preferably has a shorter response time to the server.

A tiered control system has a possibility that the data storing region of the copy-source storage device 1 fluctuates depending on the access frequency to the data. However, in the storage device 1 of an example of the first embodiment, the copy buffer selector 115 can select an appropriate secondary copy buffer 22 according to the fluctuation in the data storing region.

(B) Modification:

The disclosed technique isnot limited to the foregoing embodiment, the various changes and modification can be suggested without departing from the spirit of the embodiment. The respective configurations and procedures of the first embodiment may be selected, omitted, or combined according to the requirements.

In the above example of an example of the first embodiment, the DE 20 of the storage device 1 includes multiple secondary copy buffers 22 (e.g., the high-speed secondary copy buffer 22a and the low-speed secondary copy buffer 22b of FIG. 2) of two or more kinds, but the number and the type of the secondary copy buffers 22 are not limited to these.

The DE 20 of the storage device 1 according to a modification to the first embodiment includes one or more secondary copy buffers 22.

The copy buffer selector 115 determines whether the data destined for the other storage device 1a is to be stored in the secondary copy buffer 22 on the basis of the synchronous copying time Ts and the asynchronous copying time Tas calculated in the same manner as the above example of the first embodiment.

For example, in cases where using the high-speed secondary copy buffer 22a having the highest processing speed among the multiple secondary copy buffers 22 of two or more types does not satisfy the relationship of Tas≧Ts, the copy buffer selector 115 determines that the secondary copy buffer 22 is not used.

As understood from the above, the modification to the first embodiment attains the following effects in addition to the same effects as the above first embodiment.

In cases where the asynchronous copying time Tas is smaller than the synchronous copying time Ts, the data destined for the other storage 1a is not stored into the secondary copy buffer 22, so that the response time to the server in synchronous data copying can be shortened.

According to the information processing apparatus disclosed herein can optimize the time for synchronous data copying.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A storage device communicably connected to another storage device, the storage device comprising:
a plurality of copy buffers of two or more types that are to store data to be transmitted to the other storage device;
a first delay time measure that measures a first delay time occurring on a communication path between the storage device and the other storage device; and
a copy buffer selector that selects, on the basis of a result of comparison between the largeness of the first delay time and that of a threshold, one from the plurality of copy buffers as a copy buffer that is to store the data to be transmitted to the other storage device.

2. The storage device according to claim 1, further comprising:
a second delay time measure that measures a second delay time occurring on a communication path between the storage device and a superordinate device; and
a third delay time measure that measures a third delay time occurring in data access to a storing device included in the storage device, wherein
the copy buffer selector calculates the threshold based on the second delay time and the third delay time.

3. The storage device according to claim 2, further comprising:
a fourth delay time measure that measures fourth delay times occurring in data access to the plurality of copy buffers, wherein
when the sum of the second delay time and the third delay time is equal to or less than the twice the first delay time, the copy buffer selector selects one of the plurality of copy buffers that has a minimum fourth delay time.

4. The storage device according to claim 3, wherein when the sum of the second delay time and the third delay time is larger than the twice the first delay time, the copy buffer selector selects one of the plurality of copy buffers, the third delay time being equal to or larger than the sum of the twice the first delay time and the fourth delay time of the selected copy buffer.

5. The storage device according to claim 4, wherein the copy buffer selector selects one of the plurality of copy buffers, the third delay time being the closest to the sum of the twice the first delay time and the fourth delay time of the selected copy buffer.

6. The storage device according to claim 1, wherein the measuring of the first delay time by the first delay time measure and the selecting of one from the plurality of copy buffers by the copy buffer selector are repetitiously performed before and during data writing.

7. A controller disposed in a storage device communicably connected to another storage device, the controller comprising:
a first delay time measure that measures a first delay time occurring on a communication path between the storage device and the other storage device; and
a copy buffer selector that selects, on the basis of a result of comparison between the largeness of the first delay time and that of a threshold, one from a plurality of copy buffers of two or more types as a copy buffer that is to store the data to be transmitted to the other storage device, the plurality of copy buffers being included in the storage device.

8. The controller according to claim 7, further comprising:
a second delay time measure that measures a second delay time occurring on a communication path between the storage device and a superordinate device; and
a third delay time measure that measures a third delay time occurring in data access to a storing device included in the storage device, wherein
the copy buffer selector calculates the threshold based on the second delay time and the third delay time.

9. The controller according to claim 8, further comprising:
a fourth delay time measure that measures fourth delay times occurring in data access to the plurality of copy buffers, wherein
when the sum of the second delay time and the third delay time is equal to or less than the twice the first delay time, the copy buffer selector selects one of the plurality of copy buffers that has a minimum fourth delay time.

10. The controller according to claim 9, wherein when the sum of the second delay time and the third delay time is larger than the twice the first delay time, the copy buffer selector selects one of the plurality of copy buffers, the third delay time being equal to or larger than the sum of the twice the first delay time and the fourth delay time of the selected copy buffer.

11. The controller according to claim 10, wherein the copy buffer selector selects one of the plurality of copy buffers, the third delay time being the closest to the sum of the twice the first delay time and the fourth delay time of the selected copy buffer.

12. The controller according to claim 7, wherein the measuring of the first delay time by the first delay time measure and the selecting of one from the plurality of copy buffers by the copy buffer selector are repetitiously performed before and during data writing.

13. A non-transitory computer-readable recording medium having stored therein a control program causing a computer disposed in a storage device communicably connected to another storage device to execute a process comprising:
measuring a first delay time occurring on a communication path between the storage device and the other storage device; and
selecting, on the basis of a result of comparison between the largeness of the first delay time and that of a threshold, one from a plurality of copy buffers of two or more types as a copy buffer that is to store the data to be transmitted to the other storage device, the plurality of copy buffers being included in the storage device.

14. The non-transitory computer-readable recording medium according to claim 13, the process further comprising:
measuring a second delay time occurring on a communication path between the storage device and a superordinate device;
measuring a third delay time occurring in data access to a storing device included in the storage device; and
calculating the threshold based on the second delay time and the third delay time.
